(19) United States
(12) Patent Application Publication
(10) Pub. No.: US 2005/0067548 A1
(43) Pub. Date: Mar. 31, 2005

(54) Bracket for fluid transport tube

(76) Inventor: Tomoki Inoue, Aichi-ken (JP)

Correspondence Address: Eugene Lieberstein, Esq.;Anderson Kill & Olick, P.C., 1251 Avenue of the Americas, New York, NY, 10020, US

(21) Appl. No.: 10/951,532

(22) Filed: Sep. 28, 2004

(30) Foreign Application Priority Data
Sep. 30, 2003 (JP) 2003-341704

(51) Int. Cl. F16M 13/00

(52) U.S. Cl. 248/635; 248/68.1; 248/71

(57) ABSTRACT

The present invention is a bracket for a fluid transport tube including an elongated bracket body having a length in a longitudinal direction, a tube clamp for holding the fluid transport tube in a direction transverse to the longitudinal direction, a mounting component for securing the bracket body and tube clamp to the side of a car wherein the mounting component comprises a bolt passage hole for passing a bolt having a bolt head through the passage hole to secure the mounting component to the side of the car and a vibration-absorbing bushing 9 made of a rubber-like resilient material with an annular fitting groove 15 in the middle of its outer circumference in the thickness direction thereof fitted to the mounting component 5 in such a manner to clamp part of said bushing between the bolt head and said mounting component, and another part of said bushing between said mounting component and the car body.

### TECHNICAL FIELD

The present invention relates to a bracket that holds a fluid transport tube such as a fuel tube for transporting fuel in automobiles or other transport vehicles.

### BACKGROUND TECHNOLOGY

To prevent a fuel tube that transports automotive fuel to an engine from contacting or interfering with other equipment, brackets must be attached at several locations on the side of the car body such that the fuel tube is supported along the side of the car body. The use of brackets to support a fuel tube along the side of the car body may permit pulsation noise from the fuel or operating noise from an engine or piston or fuel pump or the like to propagate noise to the fuel tube via the fluid or gasoline contained in the hose. The vibrations of the fuel tube will then propagate to the car cabin via the brackets, thereby generating vibration noise in the car cabin. Generation of such vibration noise disrupts the creation of a comfortable environment in an automobile or other transport vehicle.

Accordingly, there is a need for a bracket that can effectively prevent the fuel tube from transmitting vibrations into the car cabin. Examples of such a bracket include a type having a rubber anti-vibration member on the inner circumference of the clamping component or a clamp member wherein ribs are provided on the inner circumference of the anti-vibration member as is taught, e.g., in Japanese unexamined patent application publication No. 2000-310359 and in Japanese unexamined patent application publication No. 2003-106479. A bracket of this type clamps a tube with a clamping component in such a manner that the anti-vibration member wraps around the outer circumference of the fuel tube and the like, and the base portion thereof is secured to the side of the car body by a nut and bolt. The presence of a rubber anti-vibration member positioned between the clamping component and the fuel tube or the like and the presence of ribs provided on the anti-vibration member that effectively absorb vibrations make it unlikely that pulsation of the gasoline fuel or vibrations of the member to which the fuel tube is connected will propagate to the bracket. Accordingly, the use of a bracket of this type avoids pulsations or vibrations of the gasoline fuel or of the members to which the engine piston is connected to propagate through the brackets, thereby eliminating the possibility of generating loud unpleasant noises to be heard in the car cabin.

Although a bracket as described in the aforementioned patent publications can effectively prevent propagation of vibrations between the fuel tube and the bracket it nevertheless does not have an anti-vibration element between the bracket and the side of the car body. Usually, the bracket and the side of the car body have relatively high rigidity, and as a result, the use of a bracket of this type does not fully prevent the car cabin from hearing unpleasant noises derived from vibration of the fuel tube. 0006

### SUMMARY OF THE INVENTION

The present invention provides a bracket for a fluid transport tube which comprises: a tube clamp for holding the fluid transport tube; and a mounting component for securing the tube clamp or a bracket body provided with a tube clamp onto the tube holding side. The mounting component further comprises: a bolt passage hole, through which a bolt passes to give a bolting means to secure the tube clamp onto the mounting component on the tube holding side. A vibration-absorbing bushing for absorbing vibrations made of an elastic material is provided to the mounting component in such a manner that the bushing is clamped between the tube holding side and the mounting component and also between the mounting component and the bolting means. The mounting component may be, for example, a plate or plate-like strip and the bolt passage hole may be, for example, a hole or notch. The bolting means is constructed with a nut and a bolt or the like although it is the bolt that passes through the bolt passage hole. Here, a vibration-absorbing bushing is also present between the mounting component and the tube holding side; therefore, vibrations do not directly propagate from the bracket to the tube holding side. Additionally, the presence of the vibration-absorbing bushing between the mounting component and the bolting means does not allow vibrations to propagate from the bracket to the tube holding side through the bolting means.

The vibration-absorbing bushing can be a disk-like body having an annular fitting groove, which is provided in the middle of the circumference in the through-thickness direction. In addition, the vibration-absorbing bushing also has a bolt hole which is a through hole provided in the through-thickness direction. The vibration-absorbing bushing can also be characterized by a cylindrical body with flanges pointing outward, which are provided at both the first end and the second end along the longitudinal axis of a cylindrical body wherein the cylindrical body has a bolt hole, which is a through hole provided longitudinally. The vibration-absorbing bushing of this type is then fitted to the mounting component in such a manner that the bottom of the fitting groove fits into the bolt passage hole. Alternatively, the vibration-absorbing bushing is attached to the mounting component by fitting it to the peripheral portion of the bolt passage hole, followed by clamping the peripheral portion of the bolt passage hole with the flange portions pointing outward at the first and second ends along the longitudinal axis of the cylindrical body.

To ease attachment of the tube and to lower the manufacturing cost, it is preferable that the tube clamp comprises: a C-shaped (including U-shaped) clamping component made of a resin or a metal; and a vibration-absorbing layer made of an elastic material and provided inside the C-shaped clamping component. The vibration-absorbing layer may be made of a rubber, for example. However, if the C-shaped clamping component is made of a resin such as nylon (PA), the tube clamp may be made of a thermoplastic elastomer (TPE) such as an olefin (TPO) so as to mold integrally to the C-shaped clamping component.

It is desirable that C-shaped clamping component of the tube clamp has an open end portion and a non-open end portion wherein the open end portion is elongated along the fluid transport tube while the non-open end is narrowed. This configuration holds the tube firmly at the long or wide open end, thereby preventing the tube from falling off. It also allows the narrow non-open end of the tube to be continuous with the tube holding side, thereby effectively suppressing propagation of vibrations from the C-shaped clamping component to the bracket body or to the tube holding side.

The use of the bracket for a fluid transport tube of the present invention makes it possible to eliminate unpleasant noise corresponding to the propagation of vibrations of the tube to the tube holding side.

### BRIEF DESCRIPTION OF THE INVENTION

Other advantages of the present invention will be apparent from the following description of the invention when read in conjunction with the accompanying drawings of which:

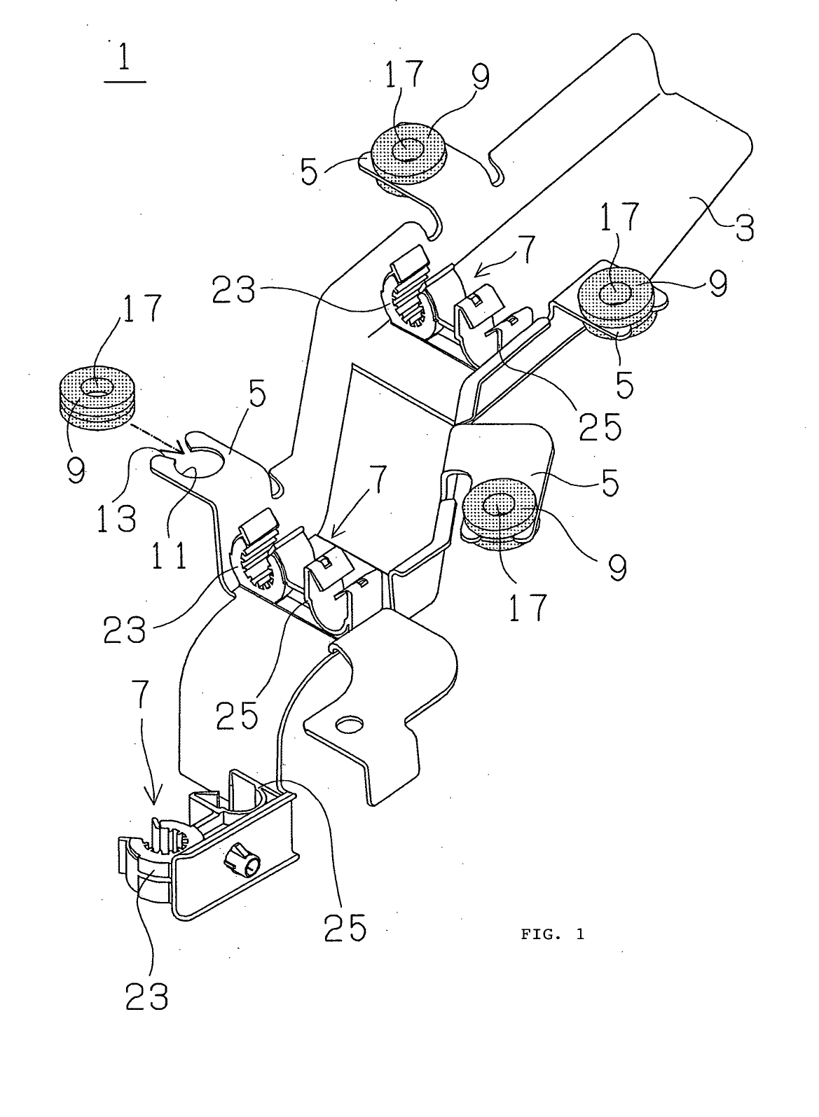

FIG. 1 is a perspective view illustrating the bracket of a fluid transport tube of the present invention for use in fuel tubes and tubing for air purge return tubes.

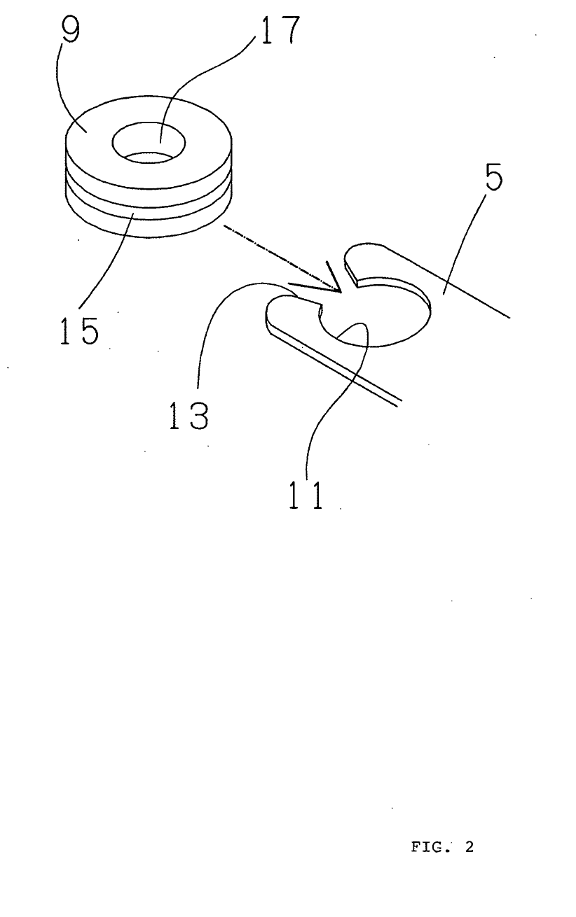

FIG. 2 is an enlarged view of the mounting component thereof.

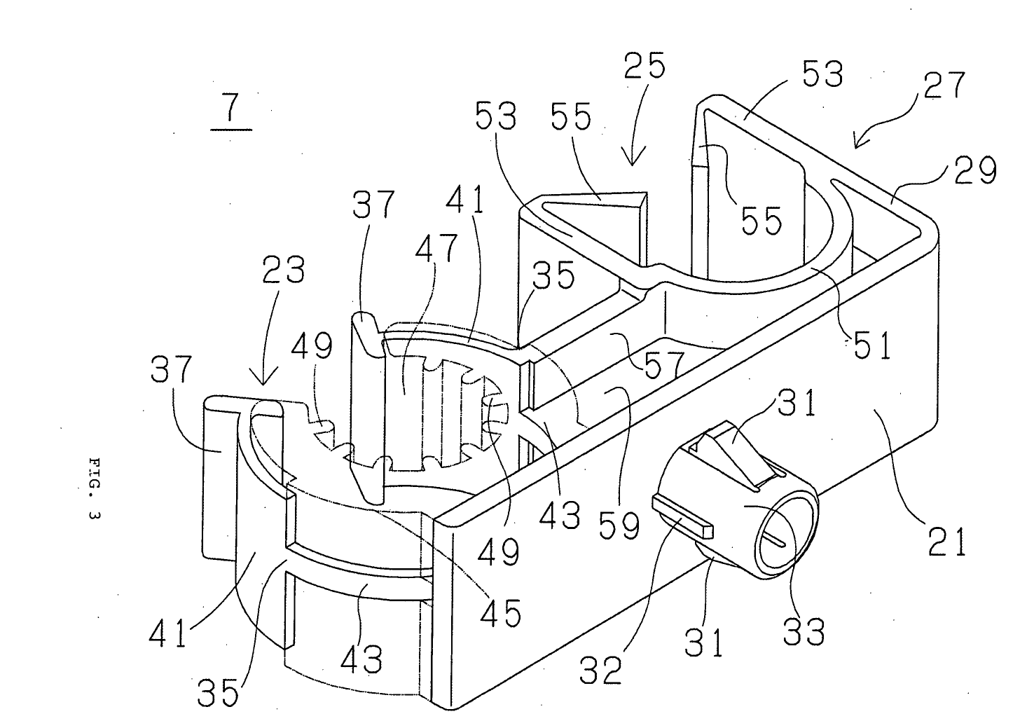

FIG. 3 is an enlarged perspective view of the clamp set thereof.

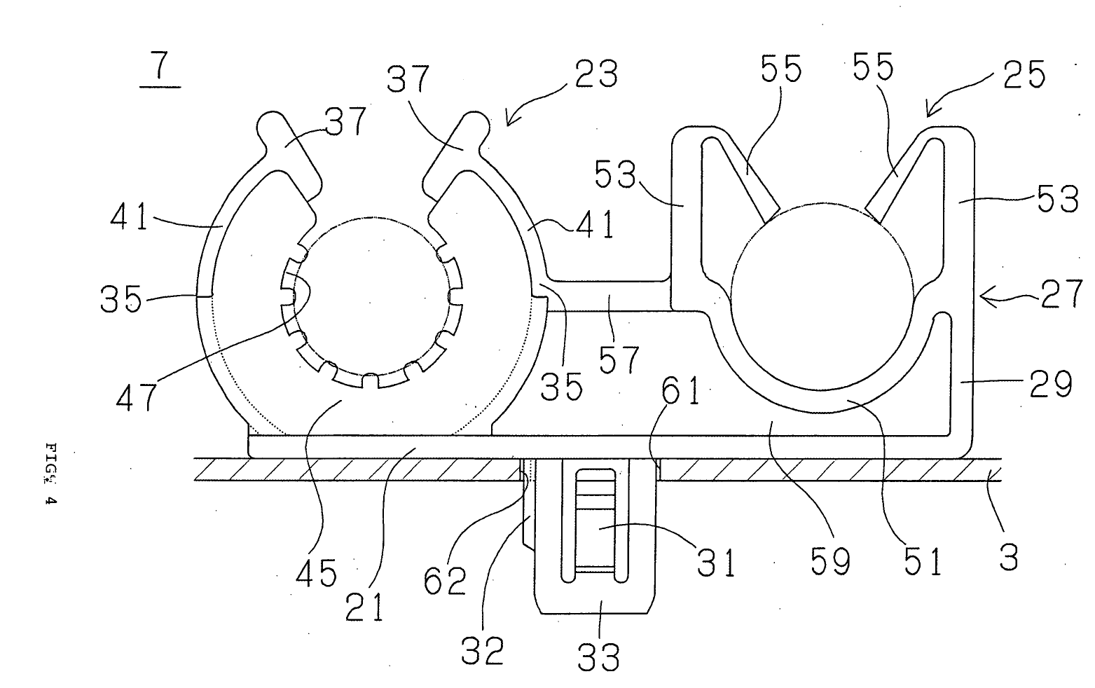

FIG. 4 is a diagram illustrating clamp set thereof being attached to bracket body.

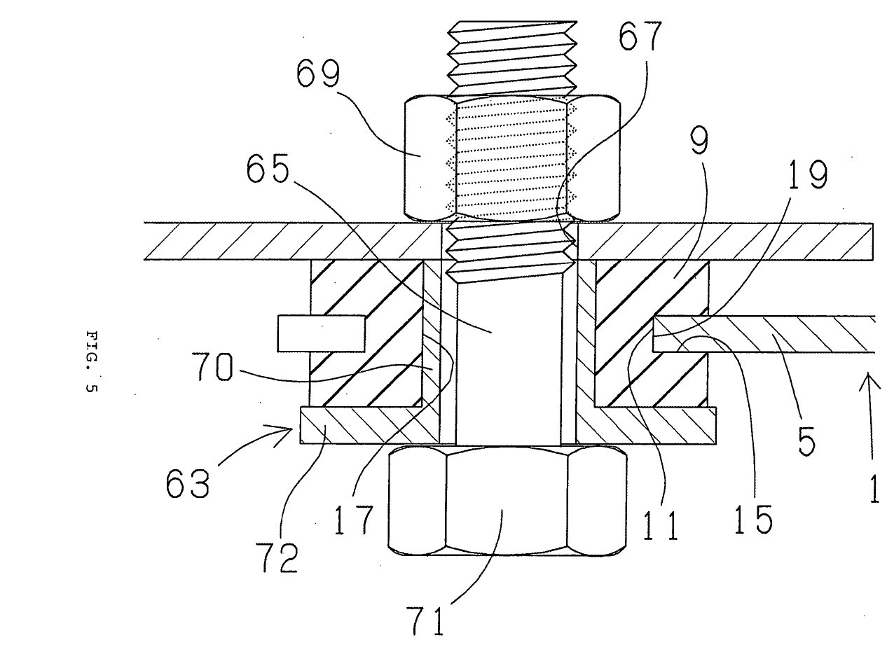

FIG. 5 is a diagram illustrating the mounting component thereof being attached to the side of the car body.

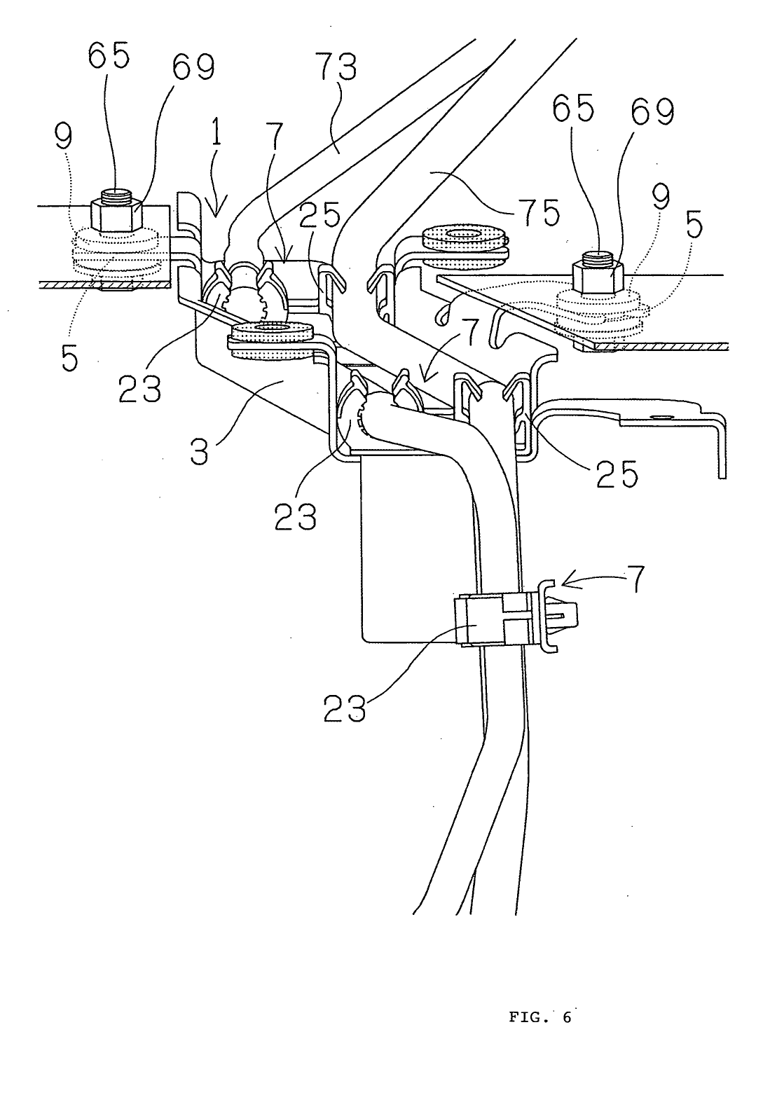

FIG. 6 is a diagram that illustrates tubing utilizing the bracket thereof.

### DETAILED DESCRIPTION OF THE PREFERRED EMBODIMENTS

Embodiments of the present invention are hereafter described with reference to FIGS. 1-6 in the drawings.

Bracket 1 representing the preferred embodiment of the present invention comprises: a bracket body 3 shaped as a relatively long plate; provided with a plurality of mounting components 5, (FIG. 1 uses four mounting components 5) which are integrally formed with the edges of bracket body 3; and provided with a plurality of clamp sets 7 (FIG. 1 uses three clamp sets 7), which are arranged longitudinally at regular intervals. The bracket body 3 is bent or curved at multiple points thereon, for example, in the longitudinal direction to trace the shape of the surface on the car body (tube holding side) where the brackets are attached.

Rubber vibration-absorbing bushings 9 are fitted to each of the mounting components 5. Mounting components 5 have a circular bolt passage hole 11 and a notch-like open portion 13 at the outer end of mounting component 5. The continuous body line of open portion 13 and bolt passage hole 11 forms a quarter circle-long opening to the outside on bolt passage hole 11. Open portion 13 gradually widens from the bolt passage hole 11 end toward the outside and its width is identical to the diameter of bolt passage hole 11 at the outer end. Accordingly, the use of a bolt passage hole 11 of this configuration makes it easier to attach vibration-absorbing bushing 9, compared to that of a simple circle.

Vibration-absorbing bushing 9 is configured as a disk-like member and the disk-like member has an annular fitting groove or a neck 15 in the center of the through-thickness direction of the outer circumference thereof and a bolt hole 17, which is a through hole provided in the through-thickness direction at the center of vibration-absorbing bushing 9. Vibration-absorbing bushing 9 is attached to mounting component 5 such that the bottom portion 19 (See FIG. 5) of fitting groove 15 is confined to bolt passage hole 11 through open portion 13 on mounting component 5. Since the diameter of bottom portion 19 of fitting groove 15 is set to be identical to the inner diameter of bolt passage hole 11, bottom portion 19 of fitting groove 15 deforms in such a manner that the width thereof becomes narrowest at the boundary end adjacent the opening between open portion 13 and bolt passage hole 11 as bottom portion 19 passes therethrough. The bottom portion 19 restores to its original circular state with a diameter larger than the opening of bolt passage hole 11 as bottom portion 19 is kept in bolt passage hole 11. Hence, vibration-absorbing bushing 9 is confined to bolt passage hole 11.

Clamp set 7 comprises: a rectangular plate-like base 21; a first clamping component 23 and a second clamping component 25 arranged in parallel with each other on base 21 along the width or longitudinal direction of the base 21; and a frame 27 formed integrally with these components on base 21 utilizing a resin material such as PA. Along the width or longitudinal edge of base 21 toward the second clamping component 25, a raised portion 29 is formed integrally with the base 21 at one end thereof. A pair of movable engagement projections 31 are provided at points about the outer circumferential diameter in a symmetrical manner wherein pin 33 or a hollow cylindrical fitting pin having an aligning projection 32 between engagement projections 31 is formed integrally with the base 21. Engagement projection 31 is continuous with fitting pin 33 at the outer edge or end portion of base 21 but is separated from fitting pin 33 other than at the outer edge or end. Each movable engagement projection 31 is triangular in cross section and functions as a depressable push button with an outer surface projecting more toward the end or edge of base 21 while tilting toward the outside. As a result, if the outer surface of engagement projection 31 is pushed inwardly, it deforms elastically to sink into fitting pin 33 using the outer edge as the base point.

The first clamping component 23 is C-shaped and includes side frames 35 having a circular shape in cross section which are integrally formed with the base 21. At the edge of the opening to each side frame 35, is a gate portion 37 formed integrally with side frame 35 such that the gate portion 37 opens in the direction orthogonal to side frame 35. The gate portions 37 provides a V shaped opening which gradually narrows down toward the base 21 or inner end thereof and is somewhat smaller at the inner end than the outer diameter of the tube to be clamped therein. Each side frame 35 in first clamping component 23 is formed integrally with a wide or plate-like pressing portion 41, which is positioned at the outside or opposite side of the base 21, and also with a narrow or fine holding portion 43 that connects the longitudinal center of pressing portion 41 and the longitudinal center of base 21. A vibration absorbing rubber layer 45, having a C-shaped cross section, is provided throughout the inner surface side of first clamping component 23, which is inside side frame 35, to cover the same length as that of pressing portion 41. Multiple convex strips 49, which extend longitudinally or along the short side direction of base 21 are provided circumferentially at even intervals wherein rubber layer 45 is illustrated in the hypothetical line in FIG. 3 for convenience. At the inner surface side 47 of rubber layer 45, the inner diameter of the hypothetical circle passing through the inner ends of convex strips 49 is set to be somewhat smaller than the outer diameter of the tube to be clamped. Rubber layer 45 is confined within both longitudinal ends of support portion 43, providing a smooth curved outer surface together with side frame 35 and rubber layer 45 throughout the same length as pressing portion 41 or the length equal to the short side of base 21. Rubber layer 45 may be integrated thereto by co-injection molding or insert molding. The vibration-absorbing layer that is C-shaped in cross section may be composed of a thermoplastic polyolefin (TPO) layer which is molded integrally with first clamping component 23.

Second clamping component 25 integrates a housing portion 51 having a semicircular cross section arranged at the end of base 21, and a pair of pressing portions 53 which extend to the outside of both ends of housing portion 51 in the width direction and also extend in the direction orthogonal to base 21. There is another pair of pressing arms 55 which extend from the outer end or tip of each pressing portion 53 to return toward housing portion 51. The inner diameter of housing portion 51 is set to be almost identical to the outer diameter of the subject return tube to be clamped while the space between a pair of pressing portions 53 is somewhat larger than the outer diameter of the subject tube. The outer edge of housing portion 51 along the width direction is connected to raised portion 29. The outer end of pressing portion 53 extends from the outer edge of raised portion 29 toward the outside. The pair of pressing arms 55 provide a funnel like space set such that it gradually narrows down toward the housing portion 51 end and coincides with the outer diameter of the subject tube to be clamped at the outer edge [of pressing arms 55]. The space at the inner edge thereof is also set to be smaller than the outer diameter of the subject tube to be clamped wherein the inner edge of pressing arm 55 is positioned almost on a hypothetical circle drawn about the inner surface of housing portion 51. The pressing portion 41 on side frame 35 which is positioned inside first clamping component 23 is connected to the pressing portion 53 positioned inside second clamping component 25 by the connecting portion 57 which is formed integrally with first and second clamping components 23, 25 and lies parallel with the base 21. Holding portion 43 inside first clamping component 23 is formed integrally with base 21 and the edge of reinforcement portion 59, which is perpendicular to base 21, between housing portion 51 in second clamping component 25 and connecting portion 57.

FIG. 4 is a diagram illustrating clamp set 7 being attached to bracket body 3.

Clamp set 7 is attached to bracket body 3 by pushing fitting pin 33 into fitting hole 61 formed on bracket body 3. The inner diameter of fitting hole 61 on bracket body 3 is almost equal to the outer diameter of fitting pin 33. If fitting pin 33 is inserted into fitting hole 61, fitting hole 61 pushes engagement projection 31 so as to sink engagement projection 31 into fitting pin 33. If fitting pin 33 is completely inserted into fitting hole 61 and the entire engagement projection 31 comes out through fitting hole 61, the engagement projection 31 then pops out from fitting pin 33 to the outside due to elastic recoil, to be engaged with the peripheral portion of fitting hole 61 on bracket body 3. Clamp set 7 is thus fitted to bracket body 3 being locked therein. Additionally, aligning groove 62 is provided to fitting hole 61 on bracket body 3 and fitting pin 33 is put into fitting hole 61 in such a manner that aligning strip 32 is caught by aligning groove 62. This configuration prevents clamp set 7 from being attached to bracket body 3 facing opposite in the width direction. The circumferential engagement of aligning strip 32 and aligning groove 62 provides clamp set 7 with an anti-rotation fitting to bracket body 3.

FIG. 5 is a diagram illustrating mounting component 5 being attached to the side of the car body.

To attach bracket 1 onto the side of the car body, one uses two of the four mounting components 5 and inserts bolt 65 into bolt hole 17 on vibration-absorbing bushing 9 being fitted into mounting component 5 via washer 63. One further inserts bolt 65 into fixing hole 67 provided on the side of the car body, and then screws nut 69 into the top portion of bolt 65. Washer 63 comprises: a cylindrical portion 70 having the same length as the thickness of vibration-absorbing bushing 9, which is inserted into bolting hole 17 on vibration-absorbing bushing 9; and flange portion 72 pointing outward and formed integrally with the outer edge of the cylindrical portion 70 wherein bolt 65 is directly inserted into cylindrical portion 70 of washer 63. Cylindrical portion 70 of washer 63 regulates the amount of tightening for vibration-absorbing bushing 9 through bolt 65 and nut 69. Mounting component 5 in bracket 1 and the side of the car body thereof are fixed in such a manner that they are clamped between head portion 71 of bolt 65 and nut 69. Vibration-absorbing bushing 9 is present between mounting component 5 and bolt 65 or washer 63 and also between the side of the car body and mounting component 5. Note that the mounting can be eased if nut 69 is fixed onto the side of the car body in advance such that bolt 65 is screwed into the tip portion of the nut 69.

FIG. 6 is a diagram that illustrates tubing utilizing bracket 1.

The tubing is completed by fitting metallic fuel tube 73 (fluid transport tube) to each first clamping component 23 of clamp set 7, which is attached to bracket 1, followed by fitting metallic return tube 75 to second clamping component 25, although bracket 1 illustrated in FIG. 1 may be modified somewhat for use in some cases. Here, the aggregate sound in the car cabin in the actual driving mode was 25 dB at 650 Hz in the absence of both rubber layer 45 and vibration-absorbing bushing 9 in first clamping component 23; 15 dB at 650 Hz in the absence of rubber layer 45 and in the presence of vibration-absorbing bushing 9 in first clamping component 23; and 8 dB at 650 Hz in the presence of both rubber layer 45 and vibration-absorbing bushing 9 in first clamping component 23.

The bracket for a fluid transport tube of the present invention can be installed in the engine compartment of an automobile, for example, to ensure a silent environment in the car cabin compartment.

1. A bracket for a fluid transport tube including a bracket body,
a tube clamp for clamping the fluid transport tube to the bracket body; and
a mounting component for securing said bracket body provided with said tube clamp to the side of a car body;
with said mounting component comprising: a bolt passage hole through which a bolt having a bolt head passes to hold said mounting component securely, and;
a vibration-absorbing bushing made of an elastic material for absorbing vibrations with said bushing being connected to said mounting component in such a manner that said bushing has one part thereof clamped between said car body and said mounting component, and another part thereof clamped between said mounting component and said bolt head.

2. A bracket for a fluid transport tube as claimed in claim 1 wherein said vibration-absorbing bushing is a disk-shaped member which further comprises a bolt hole and an annular fitting groove, located in the thickness direction of said bushing between opposite ends thereof, with said annular fitting groove secured to said mounting component in such a manner that the fitting groove fits into said bolt passage hole with the bolt hole in alignment with said bolt passage hole and with the fitting groove dividing said bushing into parts with one part thereof clamped between said car body and said mounting component, and another part thereof clamped between said mounting component and said bolt head.

3. A bracket for a fluid transport tube as claimed in claim 1 wherein said tube clamp comprises:
a C-shaped clamping component made of a resin or metal; and
a vibration-absorbing layer made of an elastic material provided on one side of said C-shaped clamping component.

4. A bracket for a fluid transport tube as cited in claim 3 wherein said C-shaped clamping component has an open end portion with an extended section having a flared geometry which has an outer diameter conforming to or greater than the diameter of the clamping component and a narrow neck located at the open end portion of a smaller diameter.

5. A bracket for a fluid transport tube as claimed in claim 2 wherein said tube clamp comprises:
a C-shaped clamping component made of a resin or metal; and
a vibration-absorbing layer made of an elastic material provided on one side of said C-shaped clamping component.
